(19) United States
(12) Patent Application Publication
(10) Pub. No.: US 2015/0006850 A1
(43) Pub. Date: Jan. 1, 2015

(54) PROCESSOR WITH HETEROGENEOUS CLUSTERED ARCHITECTURE

(71) Applicant: Samsung Electronics Co., Ltd, Suwon-si (KR)

(72) Inventors: Ki-Seok KWON, Seoul (KR); Min-Wook AHN, Seoul (KR); Dong-Kwan SUH, Hwaseong-si (KR); Suk-Jin KIM, Seoul (KR)

(73) Assignee: Samsung Electronics Co., Ltd, Suwon-si (KR)

(21) Appl. No.: 14/314,282

(22) Filed: Jun. 25, 2014

(30) Foreign Application Priority Data
Jun. 28, 2013 (KR) 10-2013-0076018

(51) Int. Cl. G06F 9/30

(52) U.S. Cl. CPC G06F 9/30141; G06F 9/30145
USPC 712/32

(57) ABSTRACT

Provided is a processor with a heterogeneous clustered architecture. The processor comprises a first cluster comprising a first functional unit configured to process a first type of instruction, and a register whose I/O ports are connected to I/O ports of the functional unit; and a second cluster comprising a second functional unit configured to process the first type of instruction and second type of instruction, and a second register whose I/O ports are connected to I/O ports of the second functional unit.

### CROSS-REFERENCE TO RELATED APPLICATIONS

This application claims the benefit under 35 U.S.C. §119(a) of Korean Patent Application No. 10-2013-0076018 filed on Jun. 28, 2013, in the Korean Intellectual Property Office, the entire disclosure of which is incorporated herein by reference for all purposes.

### BACKGROUND

1. Field

The following description relates to a processor with a clustered architecture.

2. Description of Related Art

A processor may adopt a multiple issue-and-execute architecture that executes multiple instructions at the same time for Instruction-Level Parallelism (ILP). To increase the number of instructions that the processor executes at the same time, the processor is designed with an increased number of functional units (FU). When the number of functional units increases, the number of ports to which an operand is transported from a register is also potentially increased. However, when the number of ports of a processor increases, the processor's size grows, and as a result the design also becomes more complex.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a processor with a heterogeneous clustered architecture includes a first cluster configured to execute a first type of instruction, and a second cluster configured to execute the first type of instruction and a second type of instruction.

The first cluster may include a first functional unit configured to process the first type of instruction, and a first register whose I/O ports are connected to I/O ports of the first functional unit, and the second cluster may include a second functional unit configured to process the first type of instruction and the second type of instruction, and a second register whose I/O ports are connected to I/O ports of the second functional unit, wherein the first type of instruction is more commonly used than the second type of instruction.

An output port of the second functional unit may be connected to an input port of the first register.

An output port of the first functional unit may be connected to an input port of the second register.

An output port of the first register may be connected to an input port of the second functional unit.

An output port of the second register may be connected to an input port of the first functional unit.

An input port of the first functional unit may be connected to an output port of another first functional unit of the first cluster.

An input port of the second functional unit may be connected to an output port of another second functional unit of the second cluster.

A processing time of the first type of instruction of the first cluster may be different from a processing time of the second type of instruction of the second cluster.

A processing time of the first type of instruction of the first functional unit may be less than a processing time of the first type of instruction of the second functional unit.

The first type of instruction may include a commonly or frequently used instruction and the second type of instruction may include an uncommonly used instruction or a specialized instruction.

The second type of instruction may include an instruction of the first type followed by an additional instruction.

The first cluster may be optimized to perform an instruction of the first type and the second cluster may be optimized to perform an instruction of the second type.

The first cluster may further include a multiplexer to select data to be input to the first functional unit.

The second cluster may further include a multiplexer to select data to be input to the second functional unit.

In another general aspect, a processor with heterogeneous clustered architecture includes a set of clusters, wherein each cluster comprises a register and a set of functional units that share the register and that process a same type of instruction, and a set of paths between the clusters, wherein the paths permit data exchange between clusters.

A path between clusters may include a path between an output port of a register from a cluster to an input port of a functional unit included in another cluster.

A path between clusters may include a path between an output port of a functional unit from a cluster to an input port of a register present in another cluster.

The processor may further include a multiplexer to select output from the output port of the functional unit to be output to the input port of the register.

The processor may further include an instruction fetcher configured to load instructions to be processed and an instruction decoder configured to generate a control signal to enable an instruction loaded in the instruction fetcher to be processed.

Other features and aspects will be apparent from the following detailed description, the drawings, and the claims.

### BRIEF DESCRIPTION OF THE DRAWINGS

FIG. 1 is a diagram illustrating an example of an entire system including a processor.

FIG. 2 is a diagram illustrating an example of processor structure.

FIG. 3 is a diagram illustrating an example of instructions that are processed in a processor.

FIG. 4 is a diagram illustrating an example of structures of clusters included in a processor.

FIGS. 5A and 5B are diagrams illustrating an example of data I/O between clusters.

FIGS. 6A and 6B are diagrams illustrating examples of structures of a functional unit included in a cluster.

Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the systems, apparatuses and/or methods described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art.

To solve a processor's structural problems caused by the number of functional units, in examples, a processor is provided that has a heterogeneous clustered architecture, which separates functional units inside the processor into various clusters and uses each register for each cluster.

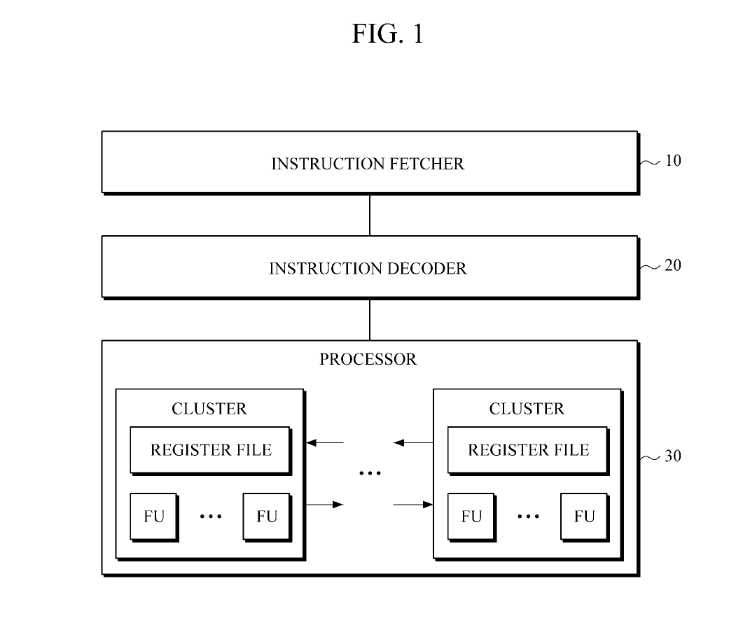

FIG. 1 is a diagram illustrating an entire system including a processor.

With reference to FIG. 1, an instruction fetcher 10 loads instructions to be processed in a processor 30. For example, the instruction fetcher 10 loads instructions to be processed in the processor 30 in advance.

An instruction decoder 20 generates a control signal to enable an instruction loaded in the instruction fetcher 10 to be processed in the processor 30. For example, to generate the control signal, the instruction decoder 20 interprets the loaded instruction.

In examples, a processor 30 simultaneously processes various instructions in parallel based on a cluster. Here, the cluster is a set including a register and a functional unit that shares the register. For example, the register of each cluster is connected to an I/O port of the functional unit located in the same cluster. A set of functional units included in the cluster potentially process the same type of instruction. Likewise, by dividing the functional unit of the processor 30 based on a type of an instruction processed by the functional units, determining which set of the functional units to include in the same cluster, and sharing the register with the functional units in a cluster unit, complexity and size of the processor 30 is reduced, thereby improving the processing speed of instructions.

For example, the structure of a functional unit included in the cluster is different according to the instruction that is to be processed. For example, a functional unit that processes a simple arithmetic operation instruction has a relatively simple structure and a small size. However, a functional unit that processes a complex arithmetic operation instruction has a relatively complex structure and a larger size compared to the functional unit processing the simple arithmetic operation instruction. The increase in complexity and size is due to the fact that a functional unit that processes more complex operation instructions requires additional elements in order to be able to carry out the more complex operation. In an example, the processor 30 has a heterogeneous clustered architecture. In such an example, the processor 30 is designed with architecture in which all of the clusters are capable of processing relatively frequent or common types of instructions, but where only some parts of the clusters are capable of processing rarely used or uncommon instructions. As a result, a processing efficiency of the frequently or commonly used instructions, as well as the uncommon instructions, is improved, because the processor 30 is able to process uncommon instructions when necessary, but does not allocate excessive or unnecessary resources by requiring all of the clusters are capable of processing all of the instructions.

In addition, the processor 30 designed with the heterogeneous clustered architecture is able to easily port the already designed processor 30 to different application fields and types of use. Thus, when ported to other application fields, the frequently or commonly used instructions are used without additional corrections, and only the cluster processing the uncommon instructions, which are used rarely or for a particular use, are redesigned. Thus, the development time of the processor is reduced, because only certain parts of the processor 30 need changes, and as result some development work is avoided.

Examples of processor or cluster composition are further described, to present aspects of certain examples.

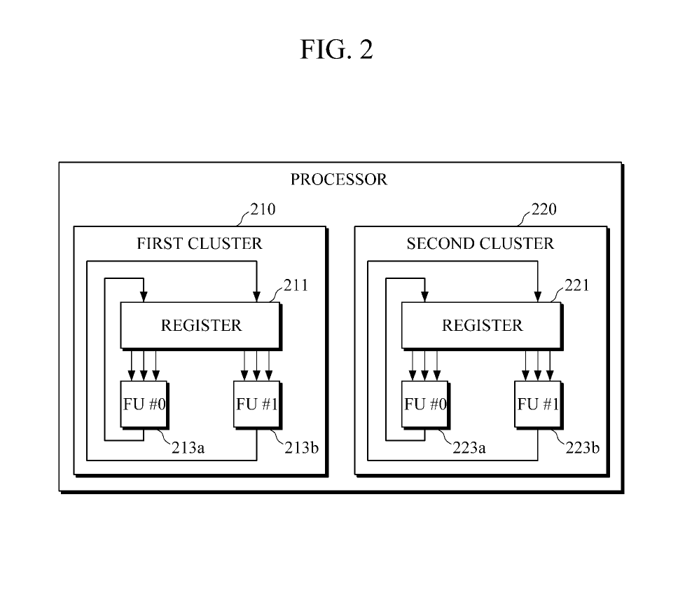

FIG. 2 is a diagram illustrating an example of processor structure.

An instruction processed by a processor of FIG. 2 is classified, for example, into a first type and a second type. In such an example, on the basis of application fields, a commonly used instruction is classified into the first type of instruction, and an uncommon instruction used for a specific purpose is classified into the second type of instruction. Alternatively, on the basis of measured usage frequency, a frequently used instruction is classified into the first type of instruction, and a rarely used instruction is classified into the second type of instruction. For example, typically frequently used instructions, such as an arithmetic operation, a bitwise operation, a comparison operation, a shifting, or a memory access, that are often frequently used in many applications, are potentially classified into the first type of instruction. Also, instructions used more often for specific application fields or of a low usage frequency, such as a maximum value operation, are classified into the second type of instruction. However, although the first and second type of instruction are described above as being classified on the basis of versatility or usage frequency, it is also possible to for the first type of instruction and the second type of instruction to be classified on various other bases or criteria, such as an instruction processing speed, area size of the functional unit for processing the instruction, processor complexity, and other factors.

In the example of FIG. 2, a first cluster 210 includes a set of first functional units 213a and 213b that executes a first type of instruction. Also, the first cluster 210 further includes a first register 211. Here, the first register 211 may be connected to I/O ports of the first functional units 213a and 213b. Through the I/O ports of the first functional units 213a and 213b, the first register 211 outputs and offers data, which is needed to process the instruction, to the first functional units 213a and 213b. Additionally in the example of FIG. 2, the first register 211 receives and stores the output of the first functional units 213a and 213b from the output ports of the first functional units 213a and 213b.

For example, a second cluster 220 includes both the first type of instruction and a set of second functional units 223a and 223b that execute the second type of instruction. In addition, the second cluster 220 further includes a second register 221. Here, the second register 221 is connected to I/O ports of the second functional units 223a and 223b. Through the I/O ports of the second functional units 223a and 223b, the second register 221 outputs and offers data, which is used to process the instruction, to the second functional units 223a and 223b. Additionally in the example of FIG. 2, the second register 221 receives the outputs from the output ports of the second functional units 223a and 223b as the input.

Here, a size of the second cluster 220 that executes both the first and second types of instruction is generally larger than the first cluster 210 that executes only the first type of instruction. In addition, a circuit of the second cluster 220 is potentially more complicated than a circuit of the first cluster 210.

As described above, providing the processor with a heterogeneous clustered architecture potentially improves efficiency of the processor. For example, the first cluster 210 is designed to be optimized for processing the first type of instruction, and so it processes the first type of instruction quickly and efficiently. In such an example, the second cluster 220 is designed to be optimized for processing the second type of instruction, and so it processes the second type of instruction quickly. However, when necessary, the second cluster 220 is capable of processing the first type of instruction as well.

In FIG. 2, the processor is illustrated as including the first cluster 210 and the second cluster 220. However, FIG. 2 is only one example that is presented for convenience of description, and in other examples, the processor may have more clusters. In addition, by specifically classifying the instruction type of the functional units of the processor, the processor more clearly segments the clusters. For example, in other examples that include more clusters, the instructions are potentially divided into more than two types and the clusters each have the ability to process at least one of the types of instructions, such that at least one cluster is capable of processing each of the types of instructions.

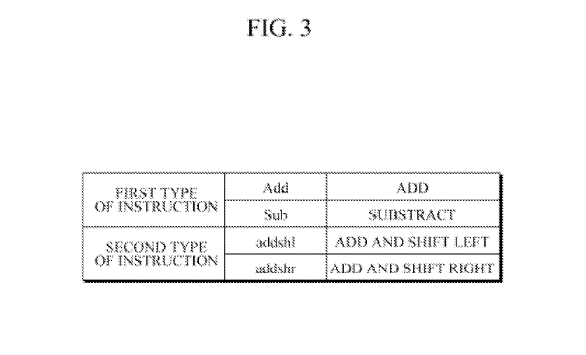

FIG. 3 is a diagram illustrating an example of instructions that can be processed in a processor.

FIG. 3 illustrates examples of instructions that can be processed by a first cluster and a second cluster. The first cluster processes a first type of instruction, and the second cluster processes both the first type of instruction and the second type of instruction.

Referring to FIG. 2, a first cluster 210 processes the first type of instruction that is generally or frequently used, and a second cluster 220 processes both the first type of instruction and the second type of instruction that is used in specific application fields or uncommonly used.

For example, with respect to FIGS. 2 and 3, the first cluster 210 only processes the first type of instruction. In the example of FIG. 3, the first type of instructions includes, for example, frequently used arithmetic, such as an addition operation or a subtraction operation. However, the second cluster 220 processes both the first type of instruction and the second type of instruction that is uncommonly or infrequently used. For example, the second cluster 220 processes the second type of instructions that are infrequently used, such as a shift arithmetic operation ‘addshr’ that executes an addition operation and then shifts right, and a shift arithmetic operation ‘addshl’ that executes an addition operation and then shifts left.

In an example, the second type of instruction that is processed in the second cluster 220 is related to the first type of instruction. In such an example, the second cluster is designed to share circuits for processing the first type of instruction and the second type of instruction. In this situation, the second cluster is designed to add a minimal amount of additional circuitry to the first cluster 210 that processes the first type of instruction, and enables the second type of instruction to be processed only by the second cluster 220 by using the additional circuitry. Using such an approach, the processor avoids waste of a hardware area that can be generated in a homogeneous clustered architecture. For example, when the first type of instruction is an addition operation, and the second type of instruction is a shift arithmetic operation that executes an addition operation and then shifts, the second cluster may be designed to share the circuit for the addition operation, and use supplementary circuitry to perform the shift.

In an example, processing time of the first type of instruction of the first cluster 210 potentially differs from the processing time of the second type of instruction of the second cluster 220. In other words, because the first cluster 210 designed to process only the first type of instruction is optimized for processing the first type of instruction, the first cluster 210 has a relatively short processing time. However, in this example the second cluster 220 that processes both the first type and the second type of instructions is designed to have a relatively long processing time considering the size and circuit complexity in the second cluster 220.

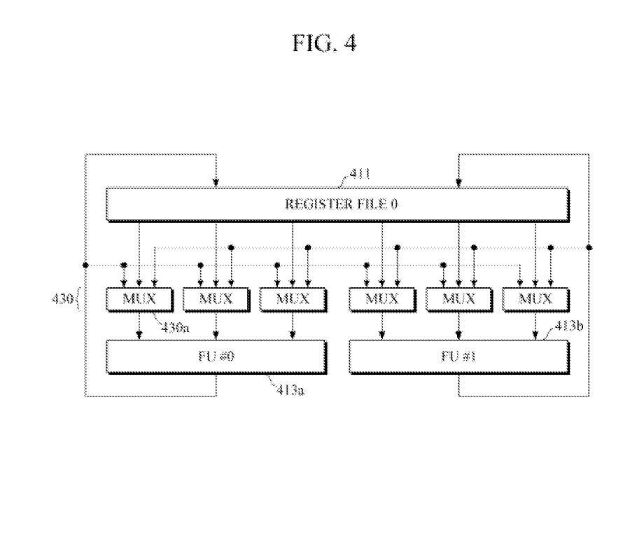

FIG. 4 is a diagram illustrating an example of composition of clusters included in a processor.

A cluster illustrated in FIG. 4 supports operand forwarding. More specifically, output from one of the functional units is input to another functional unit without passing through a register.

In the example of FIG. 4, the cluster includes a register 411, functional units 413a and 413b, and multiplexers 430.

A register 411 temporarily stores data needed to process an instruction. For example, the register 411 temporarily stores an operand to process the instruction, or data of an intermediate processing result and similar data used by the instruction. The instruction is processed in a functional unit. More specifically, the register 411 receives and stores the operand from memory or a cache. In an example, the register 411 receives data input from an output port of functional units 413a and 413b. The output port of the register 411 is connected to multiplexers 430, and depending on selection by the multiplexers 430, the data stored in the register 411 is input to the functional units 413a and 413b.

The multiplexers 430 select data to be input to the functional units 413a and 413b. The multiplexers 430 selectively input the output from the functional units 413a and 413b, and the output from the register 411 to the functional units 413a and 413b. For example, the multiplexer 430a selects and outputs one of the inputs, which is received from FU #0 413a, FU #2 413b, and the register 411, to select which data is to be input to FU #0 413a.

The functional units 413a and 413b receive data from the multiplexers 430. The functional units 413a and 413b process and output the instruction based on data received from the multiplexer 430. For example, FU #0 413a receives input of data stored in the register 411, and processes the instruction based on the input data. Also, FU #0 413a receives a processing result of FU #1 413b, and processes the instruction. In addition, FU #0 413a receives the processing result of FU #0 413a and processes the instruction. Likewise, performance degradation of the processor is prevented by using the output of the functional units 413a and 413b as direct inputs of the functional units 413a and 413b without passing through the register 411.

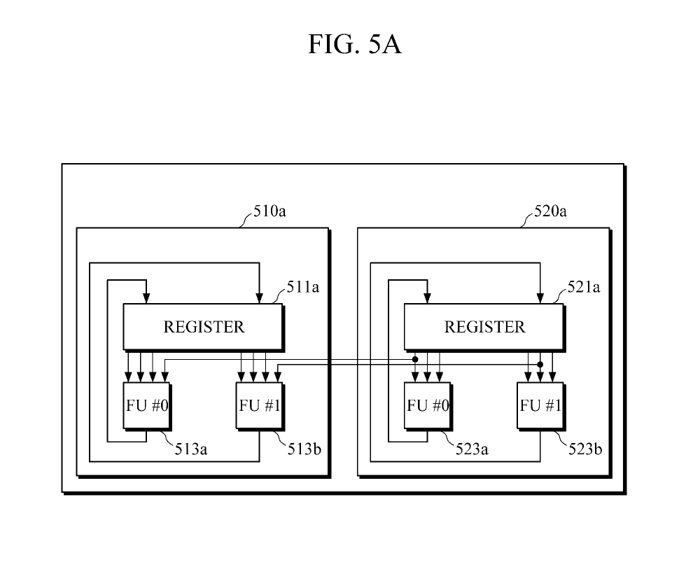

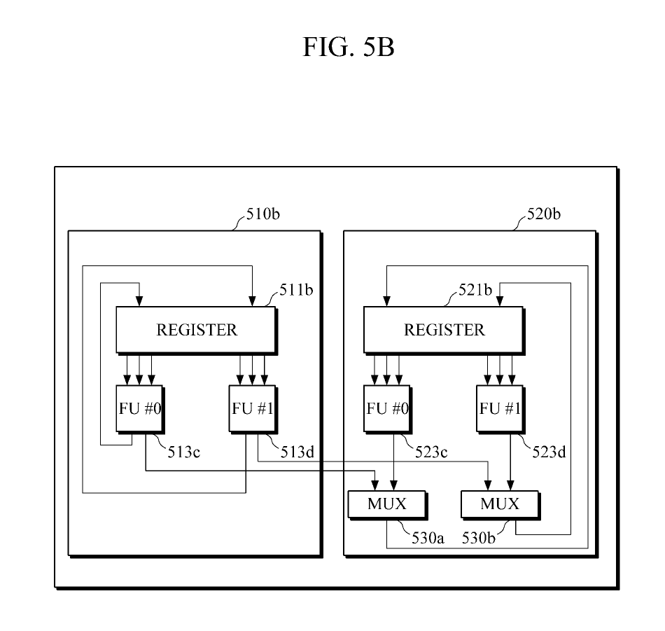

FIGS. 5A and 5B are diagrams illustrating an example of data I/O between clusters.

As illustrated in the example of FIGS. 5A and 5B, a processor supports direct cross forwarding (DCF). Here, the direct cross forwarding indicates direct data exchange between clusters. That is, there may not be a path for the data exchange between the clusters included in the processor as illustrated in FIG. 2. However, depending on the situation, the processor potentially has a direct path for the data exchange between the clusters as illustrated in FIGS. 5A and 5B, and supports the direct data exchange between the clusters.

FIG. 5A is an example of a processor with a path for data exchange between clusters. The processor has a path to input data, which is stored in a predetermined cluster, to a functional unit of another cluster. Thus, an output port of the register included in the predetermined cluster is connected to an input port of a functional unit included in another cluster. In the example of FIG. 5A, an output port of a register 521a included in a predetermined cluster 520a is connected to an input port of a functional unit 513a included in another cluster 510a. Through such ports connected between the clusters, the data is directly exchanged between the clusters.

However, if there are various paths of data that are input into the functional units, the instruction being executed in the functional units is potentially encoded to further include information for selecting data that is input into the functional units.

FIG. 5B is another example of a processor with a path for data exchange between clusters. A processor includes paths to store, in a register of another cluster, output from functional units of a predetermined cluster. So, in the example of FIG. 5B, output ports of the functional units included in the predetermined cluster are connected to input ports of the register included in another cluster. Referring to FIG. 5B, the output ports of functional units 513c and 513d of a predetermined cluster 510b are connected to the input ports of a register 512b of another cluster 520b. In addition, in the example of FIG. 5B, the processor includes multiplexers 530a and 530b to select output to be stored in the register 521b.

For example, in a case in which there are various paths to store output of the functional units, the processor is designed to encode an instruction or use a predetermined register for each instruction, in order to further include information for selecting data that is output from the functional unit.

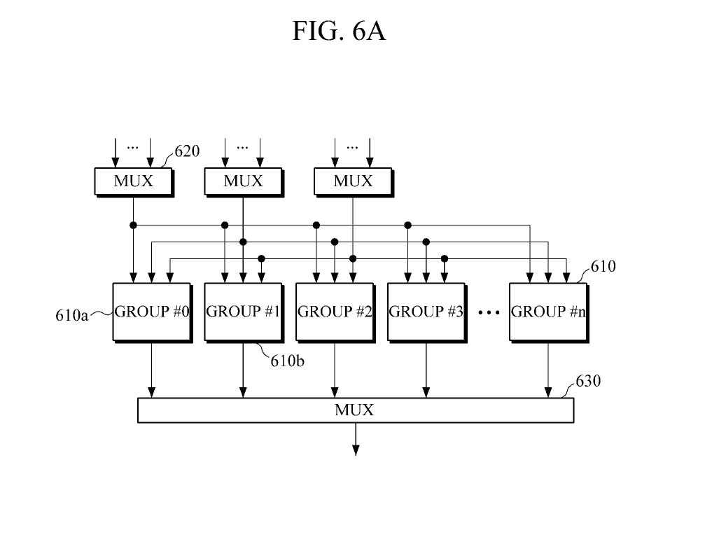

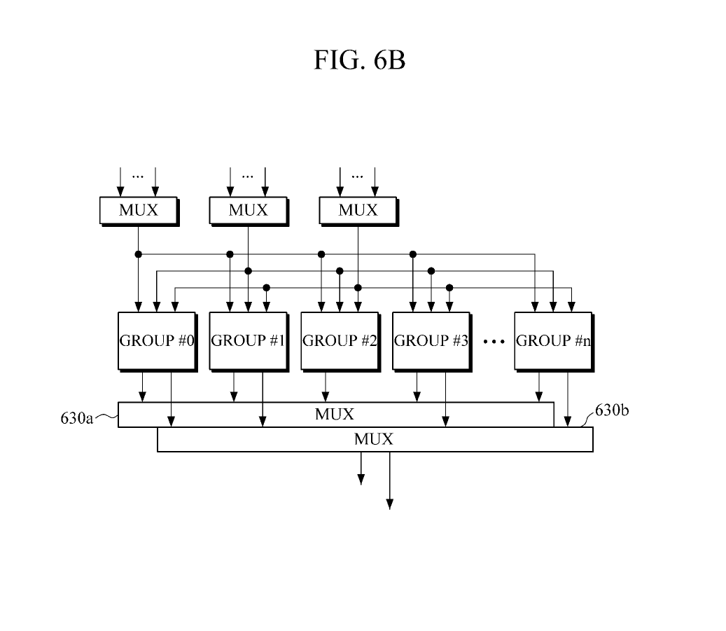

FIGS. 6A and 6B are diagrams illustrating examples of structures of a functional unit included in a cluster.

In the example of FIGS. 6A and 6B, a functional unit includes one or more operation groups 610. Here, one of the operation groups 610 receives data and processes one or more instructions. A hardware configuration affects which instructions are to be processed in which operation group. For example, an operation group #0 610a processes addition and subtraction operations, and an operation group #1 610b processes a multiplication operation. However, the operation groups 610 may vary in structure and size depending on processible instruction types corresponding to each group.

For example, a first multiplexer 620 selects data to be input to the operation groups 610. In various examples, the first multiplexer 620 select and output one from data stored in the register, output data from the functional unit of the same cluster, or data transferred from another cluster. By performing those operations, the first multiplexer 620 selects, among various available inputs, which data is to be input to the operation groups 610.

A second multiplexer 630 controls overall output. That is, the second multiplexer 630 determine which processing result is to be output among processing results that are received from a plurality of the operation groups 610.

In another example, in a case in which a functional unit has a plurality of output ports, a processor may include a plurality of second multiplexers 630a and 630b, as illustrated in FIG. 6B, to select a output port.

The apparatuses and units described herein may be implemented using hardware components. The hardware components may include, for example, controllers, sensors, processors, generators, drivers, and other equivalent electronic components. The hardware components may be implemented using one or more general-purpose or special purpose computers, such as, for example, a processor, a controller and an arithmetic logic unit, a digital signal processor, a microcomputer, a field programmable array, a programmable logic unit, a microprocessor or any other device capable of responding to and executing instructions in a defined manner. The hardware components may run an operating system (OS) and one or more software applications that run on the OS. The hardware components also may access, store, manipulate, process, and create data in response to execution of the software. For purpose of simplicity, the description of a processing device is used as singular; however, one skilled in the art will appreciate that a processing device may include multiple processing elements and multiple types of processing elements. For example, a hardware component may include multiple processors or a processor and a controller. In addition, different processing configurations are possible, such as parallel processors.

The methods described above can be written as a computer program, a piece of code, an instruction, or some combination thereof, for independently or collectively instructing or configuring the processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The media may also include, alone or in combination with the software program instructions, data files, data structures, and the like. The non-transitory computer readable recording medium may include any data storage device that can store data that can be thereafter read by a computer system or processing device. Examples of the non-transitory computer readable recording medium include read-only memory (ROM), random-access memory (RAM), Compact Disc Read-only Memory (CD-ROMs), magnetic tapes, USBs, floppy disks, hard disks, optical recording media (e.g., CD-ROMs, or DVDs), and PC interfaces (e.g., PCI, PCI-express, WiFi, etc.). In addition, functional programs, codes, and code segments for accomplishing the example disclosed herein can be construed by programmers skilled in the art based on the flow diagrams and block diagrams of the figures and their corresponding descriptions as provided herein.

As a non-exhaustive illustration only, a terminal/device/unit described herein may refer to mobile devices such as, for example, a cellular phone, a smart phone, a wearable smart device (such as, for example, a ring, a watch, a pair of glasses, a bracelet, an ankle bracket, a belt, a necklace, an earring, a headband, a helmet, a device embedded in the cloths or the like), a personal computer (PC), a tablet personal computer (tablet), a phablet, a personal digital assistant (PDA), a digital camera, a portable game console, an MP3 player, a portable/personal multimedia player (PMP), a handheld e-book, an ultra mobile personal computer (UMPC), a portable lab-top PC, a global positioning system (GPS) navigation, and devices such as a high definition television (HDTV), an optical disc player, a DVD player, a Blu-ray player, a setup box, or any other device capable of wireless communication or network communication consistent with that disclosed herein. In a non-exhaustive example, the wearable device may be self-mountable on the body of the user, such as, for example, the glasses or the bracelet. In another non-exhaustive example, the wearable device may be mounted on the body of the user through an attaching device, such as, for example, attaching a smart phone or a tablet to the arm of a user using an armband, or hanging the wearable device around the neck of a user using a lanyard.

A computing system or a computer may include a microprocessor that is electrically connected to a bus, a user interface, and a memory controller, and may further include a flash memory device. The flash memory device may store N-bit data via the memory controller. The N-bit data may be data that has been processed and/or is to be processed by the microprocessor, and N may be an integer equal to or greater than 1. If the computing system or computer is a mobile device, a battery may be provided to supply power to operate the computing system or computer. It will be apparent to one of ordinary skill in the art that the computing system or computer may further include an application chipset, a camera image processor, a mobile Dynamic Random Access Memory (DRAM), and any other device known to one of ordinary skill in the art to be included in a computing system or computer. The memory controller and the flash memory device may constitute a solid-state drive or disk (SSD) that uses a non-volatile memory to store data.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A processor with a heterogeneous clustered architecture, comprising:
a first cluster configured to execute a first type of instruction; and
a second cluster configured to execute the first type of instruction and a second type of instruction.

2. The processor of claim 1, wherein the first cluster comprises a first functional unit configured to process the first type of instruction, and a first register whose I/O ports are connected to I/O ports of the first functional unit; and
the second cluster comprises a second functional unit configured to process the first type of instruction and the second type of instruction, and a second register whose I/O ports are connected to I/O ports of the second functional unit,
wherein the first type of instruction is more commonly used than the second type of instruction.

3. The processor of claim 2, wherein an output port of the second functional unit is connected to an input port of the first register.

4. The processor of claim 2, wherein an output port of the first functional unit is connected to an input port of the second register.

5. The processor of claim 2, wherein an output port of the first register is connected to an input port of the second functional unit.

6. The processor of claim 2, wherein an output port of the second register is connected to an input port of the first functional unit.

7. The processor of claim 2, wherein an input port of the first functional unit is connected to an output port of another first functional unit of the first cluster.

8. The processor of claim 2, wherein an input port of the second functional unit is connected to an output port of another second functional unit of the second cluster.

9. The processor of claim 1, wherein a processing time of the first type of instruction of the first cluster is different from a processing time of the second type of instruction of the second cluster.

10. The processor of claim 2, wherein a processing time of the first type of instruction of the first functional unit is less than a processing time of the first type of instruction of the second functional unit.

11. The processor of claim 1, wherein the first type of instruction comprises a commonly or frequently used instruction and the second type of instruction comprises an uncommonly used instruction or a specialized instruction.

12. The processor of claim 1, wherein the second type of instruction comprises an instruction of the first type followed by an additional instruction.

13. The processor of claim 1, wherein the first cluster is optimized to perform an instruction of the first type and the second cluster is optimized to perform an instruction of the second type.

14. The processor of claim 2, wherein the first cluster further comprises a multiplexer to select data to be input to the first functional unit.

15. The processor of claim 2, wherein the second cluster further comprises a multiplexer to select data to be input to the second functional unit.

16. A processor with a heterogeneous clustered architecture, comprising:
a set of clusters, wherein each cluster comprises a register and a set of functional units that share the register and that process a same type of instruction; and
a set of paths between the clusters, wherein the paths permit data exchange between clusters.

17. The processor of claim 16, wherein a path between clusters comprises a path between an output port of a register from a cluster to an input port of a functional unit included in another cluster.

18. The processor of claim 16, wherein a path between clusters comprises a path between an output port of a functional unit from a cluster to an input port of a register present in another cluster.

19. The processor of claim 18, further comprising a multiplexer to select output from the output port of the functional unit to be output to the input port of the register.

20. The processor of claim 16, further comprising an instruction fetcher configured to load instructions to be processed and an instruction decoder configured to generate a control signal to enable an instruction loaded in the instruction fetcher to be processed.
